(19) United States
(12) Patent Application Publication
(10) Pub. No.: US 2014/0373152 A1
(43) Pub. Date: Dec. 18, 2014

(54) METHOD AND DEVICE FOR SEARCHING FOR PARENT VIRUS

(71) Applicant: Tencent Technology (Shenzhen) Company Limited, Shenzhen City (CN)

(72) Inventor: Youdi Shi, Shenzhen City (CN)

(21) Appl. No.: 14/266,333

(22) Filed: Apr. 30, 2014

Related U.S. Application Data
(63) Continuation of application No. PCT/CN2013/090623, filed on Dec. 27, 2013.

(30) Foreign Application Priority Data
Jun. 17, 2013 (CN) CN 201310239124.0

(51) Int. Cl. G06F 21/56

(52) U.S. Cl. CPC G06F 21/562
USPC 726/24

(57) ABSTRACT

A method and a device for searching for a parent virus file are disclosed. The method includes: determining an arbitrary virus file as a child virus file; obtaining a computer containing the child virus file; identifying a time when the child virus file first appeared in the computer; identifying times when other virus files contained in the computer that are different from the child virus file are first executed; determining suspect parent virus files from among the other virus files, the suspect parent virus files being first executed within a predetermined time period before the time when the child virus file first appeared in the computer; and determining the parent virus file from among the suspect parent virus files. Based on a principle that the time when the parent virus file is first executed is earlier that the time when the child virus file first appears, the suspect parent virus files are determined, and the parent virus file is found from among the suspect parent virus files.

The present application is a continuation of International application PCT/CN2013/090623, filed on Dec. 27, 2013, which claims the benefit of priority to Chinese Patent Application No. 201310239124.0, entitled as “METHOD AND DEVICE FOR SEARCHING FOR PARENT VIRUS”, filed on Jun. 17, 2013 with the State Intellectual Property Office of People's Republic of China, each of which are incorporated herein by reference in their entirety.

### TECHNICAL FIELD

The present disclosure relates to network security, and in particular, to a method and a device for searching for a parent virus.

### BACKGROUND

Computer virus technologies are developing with the development of computer technologies and, accordingly, network security is threatened. There are various computer viruses, and most of them exist in the form of a file. Some virus files may generate other computer virus files by, for example, loading files or creating files. The virus file generating other computer virus files may be referred to as a parent virus or parent virus file. A generated computer virus file may be referred to as a child virus file. The parent virus file is capable of spreading viruses, and the viruses may be completely removed only if the parent virus file of the child viruses is found and removed.

Currently, a parent virus file is searched for through monitoring approaches or ways with which the parent virus generates the child viruses. However, some parent virus files generate child viruses with complicated approaches, such as loading files, creating files, driving and tampering with the Master Boot Record (MBR), and may thus avoid the monitoring. Therefore, it is difficult to find the parent virus file by monitoring the approaches with which the parent virus file generates the child viruses.

### SUMMARY

A method and a device for searching for a parent virus are provided by the disclosure, for accurately searching for the parent virus.

A method for searching for a parent virus is provided, including determining an arbitrary virus file as a child virus file; identifying or obtaining a computer containing the child virus file; identifying a time when the child virus file first appeared in the computer; identifying times when other virus files contained in the computer that are different from the child virus file are first executed; determining suspect parent virus files from among the other virus files, the suspect parent virus files being first executed within a predetermined time period before the time when the child virus file first appeared in the computer; and determining the parent virus file from among the suspect parent virus files.

Optionally, the method may further include, after determining the suspect parent virus files and before determining the parent virus file from among the suspect parent virus files: obtaining an extent of each of the suspect parent virus files; sequencing the suspect parent virus files in a descending order according to the extent of each of the suspect parent virus files; and obtaining a first number of the suspect parent virus files. In this option, determining the parent virus file may include determining the parent virus file from among the first number of the suspect parent virus files.

Optionally, determining the parent virus file from among the suspect parent virus files may include: executing the suspect parent viruses; and determining, as the parent virus file of the child virus file, a particular suspect parent virus file that generates the child virus after being executed.

Optionally, determining the suspect parent virus files from among the other virus files may include: calculating differences between the time when the child virus file first appeared in the computer and the times when the other virus files in the computer are first executed to obtain a plurality of differences; and determining, as the suspect parent virus files, a subset of the other virus files that correspond to differences in the plurality of differences with a lesser duration than the predetermined time period.

Optionally, determining, as the suspect parent virus files, the subset of the other virus files that correspond to the differences in the plurality of differences with a lesser duration than the predetermined time period comprises may include: determining, for each of the plurality of differences, whether the difference is a lesser duration than the predetermined time period. When a particular difference among the plurality of differences is a lesser duration than the predetermined ti me period, the method may include obtaining a time, corresponding to the particular difference, when a particular virus file among the other virus files is first executed; obtaining the particular virus file corresponding to the time when the particular virus file is first executed; and determining the particular virus file as one of the suspect parent virus files.

A device for searching for a parent virus is further provided. The device may include: a first determination module configured to determine an arbitrary virus file as a child virus file; a first obtaining module configured to obtain a computer containing the child virus file; a second obtaining module configured to identify a time when the child virus first appeared in the computer; a third obtaining module configured to identify times when other virus files contained in the computer that are different from the child virus file are first executed; a second determination module configured to determine suspect parent virus files from among the other virus files, the suspect parent virus files being first executed within a predetermined time period before the time when the child virus file first appeared in the computer; and a third determination module configured to determine the parent virus file from among the suspect parent virus files.

Optionally, the device may further include: a fourth obtaining module configured to obtain the extent of each of the suspect parent virus files; a sequencing module configured to sequence the suspect parent virus files in descending order according to the extent of each of the suspect parent virus files; and a fifth obtaining module configured to obtain a first number of the suspect parent virus files. In this option, the third determination module may be configured to determine the parent virus file from among the first number of the suspect parent virus files.

Optionally, the third determination module may include an execution sub-module configured to execute the suspect parent virus files; and a first determination sub-module configured to determine, as the parent virus file, a particular suspect parent virus file that generates the child virus file after being executed.

Optionally, the second determination module may include a first obtaining sub-module configured to calculate differences between the time when the child virus file first appeared in the computer and the times when the other virus files in the computer are first executed to obtain a plurality of differences; and a second determination sub-module configured to determine, as the suspect parent virus files, a subset of the other virus files that correspond to differences in the plurality of differences with a lesser duration than the predetermined time period.

Optionally, the second determination sub-module may include a judgment unit configured to determine, for each of the plurality of differences, whether the difference is a lesser duration than the predetermined time period; a first obtaining unit configured to, when a particular difference among the plurality of differences is a lesser duration than the predetermined time period, obtain a time, corresponding to the particular difference, when a particular virus file among the other virus files is first executed; a second obtaining unit configured to obtain the particular virus file corresponding to the time when the particular virus file is first executed; and a second determination unit configured to determine the particular virus file as the suspect parent virus files.

According to the embodiments, the child virus is firstly determined, and the computers containing the child virus are obtained; the time when the child virus first appears in the computers is obtained, and the time when each of virus files except the child virus in the computers is first executed is obtained; the difference between the time when the child virus first appears and the time when each of the virus files is first executed is calculated, and the virus files corresponding to the differences smaller than the preset time period are determined as the suspect parent viruses; and the parent virus is determined from the suspect parent viruses. Since the child virus is a virus file generated after executing the parent virus, based on a principle that the time when the parent virus is first executed is earlier than the time when the child virus first appears, the suspect parent viruses are determined, and the parent virus is found from the suspect parent viruses accurately.

### BRIEF DESCRIPTION OF DRAWINGS

For explaining technical solutions according to embodiments of the disclosure more clearly, drawings to be used in the description of the embodiments of the disclosure are described briefly below. Apparently, the drawings in the following description are merely some embodiments of the disclosure, and other drawings may be obtained by those skilled in the art based on these drawings without any creative work.

FIG. 1 is a flow chart of a method for searching for a parent virus according to a first embodiment of the disclosure;

FIG. 2 is a flow chart of possible steps further included in the method for searching for the parent virus according to the first embodiment of the disclosure;

FIG. 3 is a structure diagram of a device for searching for a parent virus according to a second embodiment of the disclosure; and

FIG. 4 is a schematic structure diagram of a terminal according to the second embodiment of the disclosure.

### DETAILED DESCRIPTION OF EMBODIMENTS

Technical solutions of embodiments of the disclosure are described clearly and completely hereinafter in conjunction with drawings of the embodiments of the disclosure. The described embodiments are merely embodiments of the disclosure. Any other embodiment obtained by those skilled in the art without creative work should fall within the scope of protection of the disclosure.

Since a child virus is generated by a parent virus, the time when the child virus first appears is later than the time when the parent virus of the child virus is first executed. The parent virus of the child virus is searched for based on this principle. Compared with the prior art, the parent virus is determined by a time relationship, rather than by monitoring the approach with which the parent virus generates the child virus. Therefore, the searching accuracy for the parent virus is improved.

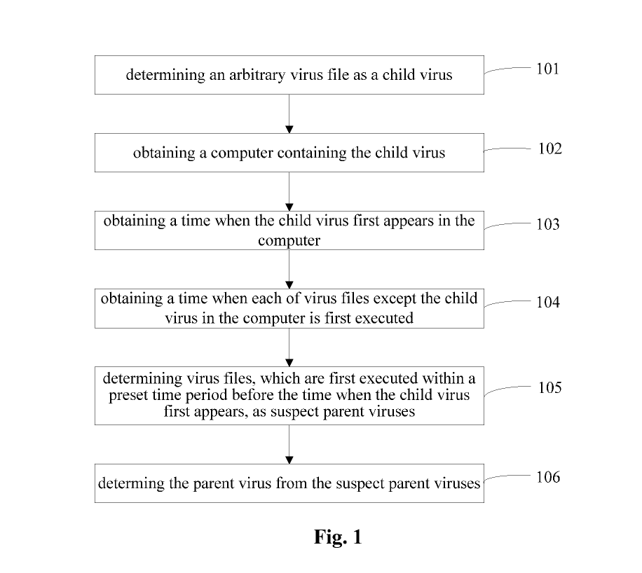

FIG. 1 is a flow chart of a method for searching for a parent virus according to an embodiment of the disclosure. The method includes the following steps 101-106.

Step 101 is, determining an arbitrary virus file as a child virus.

According to the embodiment, an arbitrary virus file is determined as a child virus before searching for the parent virus.

In practice, a virus usually exists in a form of file. The concepts of a child virus and a parent virus are conditional. One virus file may be referred to as both a child virus and a parent virus at the same time. That is, a virus file may be a file that generates another virus file, thereby being referred to as a parent virus. The same virus file and may also be a file that was generated by another virus file, thereby being referred to as a child virus. A child virus, e.g., child virus file, may be determined before searching for a parent virus that generated the child virus file. Then the parent virus can be searched for based on the child virus. In addition, different child viruses may be generated by a same parent virus.

Step 102 is, obtaining or identifying a computer containing the child virus.

According to the embodiment, one or more computers containing the child virus may be obtained after the child virus is determined. Since the child virus and the parent virus reside on the same computer, subsequent steps are performed on other virus files in the one or more computers containing the child virus.

Step 103 is, obtaining or identifying a time when the child virus first appeared in the computer.

According to the embodiment, the time when the child virus first appeared in the computer is identified after the child virus is determined.

Step 104 is, obtaining or identifying times when other virus files contained in the computer that are different from the child virus are first executed.

According to the embodiment, after the child virus is determined, the time when other virus files are first executed is obtained. The other virus files may be different from the child virus and also contained in the one or more computers. A virus file that has never been executed may not be considered a processing object in the embodiment, and the method may not (e.g., forego) considering the non-executed virus file when determining the parent virus of the child virus, according to the embodiment.

It should be noted that the execution order of step 103 and step 104 is not limited in the embodiment. Step 104 may be executed after step 103; step 103 may be executed after step 104; or step 103 and step 104 may be executed simultaneously.

Step 105 is, determining suspect parent virus files from among the other virus files, the suspect parent virus files being first executed within a predetermined time period before the time when the child virus file first appeared in the computer.

According to the embodiment, the time period may be preset or predetermined based on experience. After obtaining the times when the other virus files are first executed, the other virus files which are first executed within the predetermined time period before the time when the child virus first appeared in the computer are obtained and determined as suspect parent viruses. Put another way, differences between the time when the child virus file first appeared in the computer and the times when the other virus files in the computer are first executed are calculated to obtain a plurality of differences. The suspect parent virus files are determined as a subset of the other virus files that correspond to differences in the plurality of differences with a lesser duration than the predetermined time period, e.g., with a lesser duration than the time length of the predetermined time period.

For example, a difference between the time when the child virus first appears and the time when the other virus files are first executed is calculated. Then, the particular other virus files corresponding to the differences with a lesser duration than the predetermined time period are determined as the suspect parent viruses.

Specifically, determining, as the suspect parent virus files, the subset of the other virus files that correspond to the differences in the plurality of differences with a lesser duration than the predetermined time period may include: determining, for each of the plurality of differences, whether the difference is smaller than, e.g., less than the duration of, the preset or predetermined time period; When a particular difference among the plurality of differences is a lesser duration than the predetermined time period, the determining the subset of the other virus files as the suspect parent files may include: obtaining a time, corresponding to the particular difference, when a particular virus file among the other virus files is first executed; obtaining the particular virus file corresponding to the time when the particular virus file is first executed; and determining the particular virus file as one of the suspect parent viruses.

Step 106 is, determining, from the suspect parent viruses, the parent virus.

According to the embodiment, the parent virus is determined after the suspect parent viruses are determined. In practice, the suspect parent viruses may be executed one by one, and a particular suspect parent virus which generates the child virus after being executed is determined as the parent virus.

The child virus may have one parent virus or multiple parent viruses.

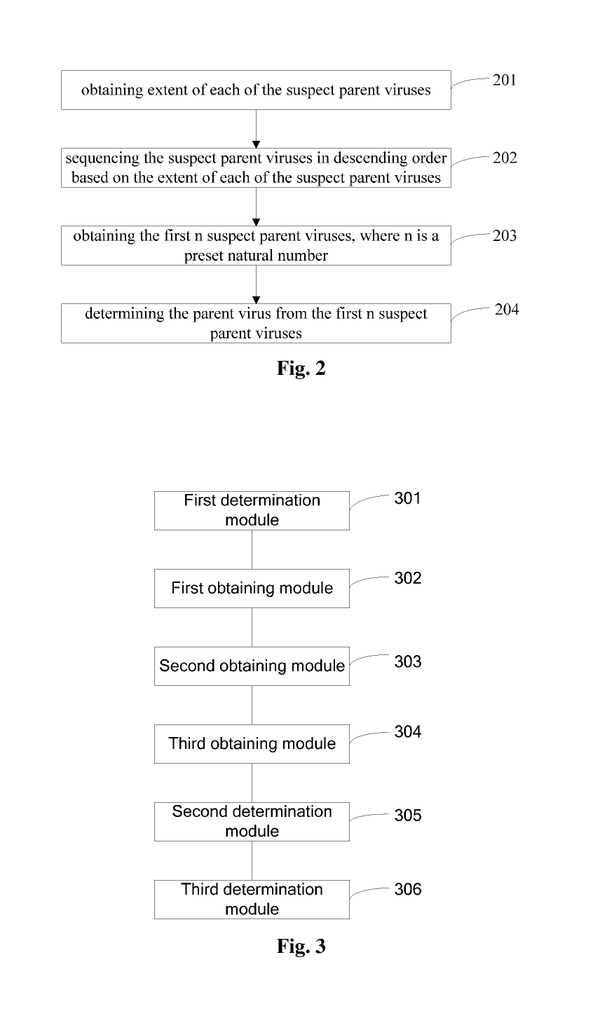

According to the embodiment, the parent virus may be further determined after the suspect parent viruses are determined in the step 105. FIG. 2 is referred to, which illustrates a flow chart of possible steps further included in the method according to the embodiment. Steps 201-203 may be performed after step 105 and before step 106, for example.

Step 201 is, obtaining extent of each of the suspect parent viruses.

According to some variations, computers containing the child virus determined in step 101 are firstly identified; then the number of computers containing each of the suspect parent viruses is identified or obtained. As one illustration, multiple computers containing the child virus are identified, and in these multiple computers, the number of computers containing suspect parent virus X is identified as 200 and the number of computers containing suspect parent virus Y is identified as 500. In this illustration, the extent of suspect parent virus X may be identified as 200 and the extent of suspect parent virus Y may be identified as 500. In this illustration, the extent of suspect parent virus Y is greater than the extent of suspect parent virus X. The extent may be measured as, for example, a number of computers, and the extent of a particular suspect parent virus may be considered as the number of computers containing this particular suspect parent virus.

Step 202 is, sequencing the suspect parent viruses in a descending order based on or according to the extent of each of the suspect parent viruses.

According to the embodiment, after the extents of the suspect parent viruses are obtained, the suspect parent viruses are sequenced in descending order based on or according to the extents. That is, a first suspect parent virus with a greater extent is sequenced before a second suspect parent virus with smaller extent, and the suspect parent viruses are sequenced in descending order one by one.

Step 203 is, obtaining the first ‘n’ suspect parent viruses, where ‘n’ is a preset natural number. Put another way, step 203 may include obtaining a first number of the suspect parent viruses.

According to the embodiment, the natural number ‘n’ is set or determined based on experience, and the first ‘n’ suspect parent viruses in the descending sequence are obtained to determine the parent virus. Since the child virus and the parent virus reside in the same computer, suspect parent viruses with greater extent are more likely to be determined as the parent virus. Therefore, the first ‘n’ suspect parent viruses with greater extents are obtained in this step.

Step 204 is, determining the parent virus from the first ‘n’ suspect parent viruses. In practice, step 106 of determining the parent virus from the suspect parent viruses may include step 204.

According to the embodiment, after the first ‘n’ suspect parent viruses with greater extents are obtained, the parent virus may be determined from the first ‘n’ suspect parent viruses. Specifically, the first ‘n’ suspect parent viruses may be executed one by one. Then a particular suspect parent virus which generates the child virus after being executed may be determined as the parent virus of the child virus.

According to the embodiment, the extents of the suspect parent viruses may be obtained, then the suspect parent viruses may be sequenced in descending order based on the extents, and the first ‘n’ number of suspect parent viruses (e.g., the suspect parent viruses with greater extents) are determined as the objects to be executed. Therefore, the number of the virus files to be executed is decreased, and the efficiency of obtaining the parent virus is accordingly improved.

According to the embodiment, a child virus is firstly determined, and the computers containing the child virus are obtained. The time when the child virus first appeared in the computers is obtained, and times other virus files contained in the computers that are different from child virus are first executed is obtained. The differences between the time when the child virus first appeared and the time when each of the other virus files is first executed is calculated, and the virus files corresponding to the differences smaller or with lesser duration than a preset or predetermined time period are determined as the suspect parent viruses. The parent virus is determined from among the suspect parent viruses. Since the child virus is a virus file generated after executing the parent virus, based on a principle that the time when the parent virus is first executed is earlier than the time when the child virus first appears, the suspect parent viruses are determined, and the parent virus may be accurately found from among the suspect parent viruses.

FIG. 3 illustrates a structure diagram of a device for searching for a parent virus according to an exemplary embodiment. The device includes a first determination module 301, a first obtaining module 302, a second obtaining module 303, a third obtaining module 304, a second determination module 305 and a third determination module 306.

The first determination module 301 is configured to determine an arbitrary virus file as a child virus. The first obtaining module 302 is configured to obtain a computer containing the child virus. The second obtaining module 303 is configured to obtain or identify a time when the child virus first appeared in the computer. The third obtaining module 304 is configured to obtain or identify times when other virus files, different from the child virus, are first executed. The other virus files may be different from the child virus and also be contained in the computer.

The second determination module 305 is configured to determine suspect parent viruses (e.g., suspect parent virus files) from among the other virus files, the suspect parent viruses being first executed within a preset or predetermined time period before the time when the child virus file first appeared in the computer.

The second determination module 305 may include: a first obtaining sub-module configured to calculate differences between the time when the child virus first appeared in the computer and the times when the other virus files contained in the computer are first executed to obtain a plurality of differences; and a second determination sub-module, configured to determine, as the suspect parent viruses, a subset of the other virus files that correspond to differences in the plurality of differences smaller than or with a lesser duration than the preset time period.

The second determination sub-module may include: a judgment unit, configured to judge or determine, for each of the plurality of differences, whether the difference is smaller than or a lesser duration than the preset time period; a first obtaining unit configured to, when a particular difference among the plurality of differences is a lesser duration than the predetermined time period, obtain a time, corresponding to the particular difference, when a particular virus file from among the other virus files is first executed; a second obtaining unit configured to obtain the particular virus file corresponding to the time when the particular virus file is first executed; and a second determination unit configured to determine the particular virus file as one of the suspect parent viruses.

The third determination module 306 is configured to determine, from the suspect parent viruses, the parent virus. In some implementations, the third determination module 306 may include an execution sub-module configured to execute the suspect parent viruses; and a first determination sub-module configured to determine a suspect parent virus, which generates the child virus after being executed, as the parent virus of the child virus.

To determine the parent virus based on the suspect parent viruses determined by the second determination module 305, the device may include a fourth obtaining module configured to obtain an extent of each of the suspect parent viruses; a sequencing module configured to sequence the suspect parent viruses in descending order based on or according to the extent of each of the suspect parent viruses; and a fifth obtaining module configured to obtain the first ‘n’ number of the suspect parent viruses, where n is a preset natural number. In some variations, the third determination module is then configured to determine parent virus from among the first ‘n’ number of suspect parent viruses.

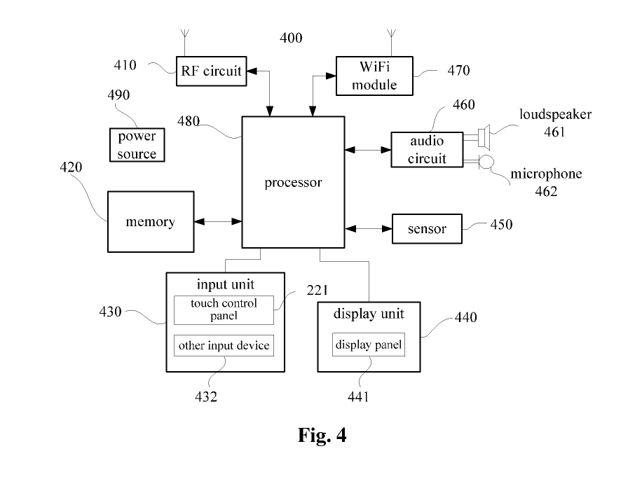

A terminal is further provided according to an embodiment of the disclosure, as shown in FIG. 4. For convenient illustration, only parts related to the embodiment of the disclosure are shown in FIG. 4, and technical details not given may refer to the method embodiment of the disclosure. The terminal may include, for example, a mobile phone, a Tablet Personal Computer, a Personal Digital Assistant (PDA), a Point of Sales (POS) and an on-board computer. Here a case that the terminal is a mobile phone is taken as an example.

FIG. 4 is a block diagram illustrating part structure of a mobile phone related to the terminal according to the embodiment of the disclosure. Referring to FIG. 4, the mobile phone includes: a Radio frequency (RF) circuit 410, a memory 420, an input unit 430, a display unit 440, a sensor 450, an audio circuit 460, a Wireless Fidelity (WiFi) module 470, a processor 480, a power source 490, etc. It should be understood by those skilled in the art that, the structure of the mobile phone shown in FIG. 4 is not intended to limit the mobile phone, more or less components than those shown in FIG. 4 may be included, some components may be combined or arranged in a different manner.

The components of the mobile phone are described in detail as follows in conjunction with FIG. 4.

The RF circuit 410 may be configured to receive and transmit signals in information receiving and transmitting and telephone communication. Specifically, the RF circuit delivers the received downlink information of the base station to the processor 480 to be processed, and transmits the uplink data to the base station. Generally, the RF circuit includes but not limited to an antenna, at least one amplifier, a transceiver, a coupler, a Low Noise Amplifier (LNA), and a duplexer. In addition, the RF circuit 410 may communicate with other devices via wireless communication and network. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), E-mail, and Short Messaging Service (SMS).

The memory 420 may be configured to store software programs and modules, and the processor 480 may execute various function applications and data processing of the mobile phone by running the software programs and modules stored in the memory 420. The memory 420 may mainly include a program storage area and a data storage area, where the program storage area may be used to store, for example, the operating system and the application required by at least one function (for example, voice playing function, image playing function), and the data storage area may be used to store, for example, data established according to the use of the terminal (for example, audio data, telephone book). In addition, the memory 420 may include a high-speed random access memory and a nonvolatile memory, such as at least one magnetic disk memory, a flash memory, or other volatile solid-state memory.

The input unit 430 may be configured to receive input numeric or character information, and to generate a keyboard signal input related to user setting and function control of the mobile phone 400. In a specific embodiment, the input unit 430 may include a touch control panel 431 and other input device 432. The touch control panel 430 is also referred to as a touch display screen, and may collect a touch operation thereon or thereby (for example, an operation on or around the touch control panel 431 that is made by the user with a finger, a touch pen and any other suitable object or accessory), and drive corresponding connection devices according to a preset procedure. Optionally, the touch control panel 431 may include a touch detection device and a touch controller. The touch detection device detects touch orientation of the user, detects a signal generated by the touch operation, and transmits the signal to the touch controller. The touch controller receives touch information from the touch detection device, converts the touch information into touch coordinates and transmits the touch coordinates to the processor 480. The touch controller is also able to receive a command transmitted from the processor 480 and execute the command. In addition, the touch control panel 431 may be implemented by, for example, a resistive panel, a capacitive panel, an infrared panel and a surface acoustic wave panel. In addition to the touch control panel 431, the input unit 430 may also include other input device 432. Specifically, the other input device 432 may include but not limited to one or more of a physical keyboard, a function key (such as a volume control button, a switch button), a trackball, a mouse and a joystick.

The display unit 440 is configured to display information input by the user or information provided for the user and various menus of the mobile phone. The display unit 440 may include a display panel 441. Optionally, the display panel 441 may be formed in a form of a Liquid Crystal Display (LCD), an Organic Light-Emitting Diode (OLED) or the like. In addition, the display panel 441 may be covered by the touch control panel 431. When the touch control panel 431 detects a touch operation thereon or thereby, the touch control panel 431 transmits the touch operation to the processor 480 to determine the type of the touch event, and then the processor 480 provides a corresponding visual output on the display panel 441 according to the type of the touch event. Although the touch control panel 431 and the display panel 441 implementing the input and output functions of the mobile phone as two separate components in FIG. 4, the touch control panel 431 and the display panel 441 may be integrated together to implement the input and output functions in other embodiment.

The mobile phone 400 may further include at least one sensor 450, such as an optical sensor, a motion sensor and other sensors. The optical sensor may include an ambient light sensor and a proximity sensor. The ambient light sensor may adjust the luminance of the display panel 441 according to the intensity of ambient light, and the proximity sensor may close the backlight or the display panel 441 when the terminal is approaching to the ear. As a kind of motion sensor, the gravity acceleration sensor may detect the magnitude of acceleration in multiple directions (usually three-axis directions) and detect the value and direction of the gravity when the sensor is in the stationary state. The acceleration sensor may be applied in, for example, an application of mobile phone pose recognition (for example, switching between landscape and portrait, a correlated game, magnetometer pose calibration), a function about vibration recognition (for example, a pedometer, knocking). Other sensors such as a gyroscope, a barometer, a hygrometer, a thermometer, an infrared sensor, which may be further provided in the mobile phone, are not described herein.

The audio circuit 460, a loudspeaker 461 and a microphone 462 may provide an audio interface between the user and the mobile phone. The audio circuit 460 may transmit an electric signal, converted from received audio data, to the loudspeaker 461, and a voice signal is converted from the electric signal and then outputted by the loudspeaker 461. The microphone 462 converts captured voice signal into an electric signal, the electric signal is received by the audio circuit 460 and converted into audio data. The audio data is outputted to the processor 480 for processing and then sent to another mobile phone via the RF circuit 410; or the audio data is outputted to the memory 420 for further processing.

WiFi is a short-range wireless transmission technique. The mobile phone may, for example, send and receive E-mail, browse a webpage and access a streaming media for the user by the WiFi module 470, and provide wireless broadband Internet access for the user. Although the WiFi module 470 is shown in FIG. 4, it can be understood that the WiFi module 470 is not necessary for the mobile phone 400, and may be omitted as needed within the scope of the essence of the disclosure.

The processor 480 is a control center of the mobile phone, which connects various parts of the mobile phone by using various interfaces and wires, and implements various functions and data processing of the mobile phone by running or executing the software programs and/or modules stored in the memory 420 and invoking data stored in the memory 420, thereby monitoring the mobile phone as a whole. Optionally, the processor 480 may include one or more processing units. Preferably, an application processor and a modem processor may be integrated into the processor 480. The application processor is mainly used to process, for example, an operating system, a user interface and an application. The modem processor is mainly used to process wireless communication. It can be understood that, the above modem processor may not be integrated into the processor 480.

The mobile phone 400 further includes a power supply 490 (such as a battery) for powering various components. Preferably, the power supply may be logically connected with the processor 480 via a power management system, therefore, functions such as charging, discharging and power management are implemented by the power management system.

Although not shown, the mobile phone 400 may also include other modules such as a camera and a Bluetooth module, which are not described herein.

Specifically, in one or more embodiments of the disclosure, in order to achieve various functions, the processor 480 in the terminal may load executable files corresponding to processes of one or more application programs, which are to be executed by the processor 480, into the memory 420. The executable files may include instructions, that when executed, cause circuitry of the terminal 400 to perform any of the functionality described herein, such as determining an arbitrary virus file as a child virus; identifying one or more computers containing the child virus; identifying a time when the child virus first appears in the computer; identifying times when other virus files different from the child virus and contained in the computer are first executed; determining suspect parent viruses from among the other virus files, the suspect parent viruses being first executed within a preset or predetermined time period before the time when the child virus file first appeared in the computer; and determining, from among the suspect parent viruses, the parent virus.

Optionally, there are further instructions that cause the processor to, after determining the suspect parent virus files and before determining the parent virus file from among the suspect parent virus files: obtain an extent of each of the suspect parent viruses; sequence the suspect parent viruses in descending order based on or according to the extent of each of the suspect parent viruses; obtain the first ‘n’ number of the sequenced suspect parent viruses, where ‘n’ is a preset natural number; and determine the parent virus from among the first ‘n’ suspect parent viruses.

Optionally, the instructions may cause the processor to determine, from among the suspect parent viruses, the parent virus by: executing the suspect parent viruses; and determining the parent virus of the child virus as a particular suspect parent virus which generates the child virus after being executed.

Optionally, the instructions may cause the processor to determine the suspect parent viruses from among the other virus files by: calculating differences between the time when the child virus first appeared in the computer and the times when the other virus files in the computer are first executed to obtain a plurality of differences; and determining, as the suspect parent virus files, the subset of the other virus files which correspond to (e.g., with) differences in the plurality of differences smaller than or with a duration less than the preset time period.

Optionally, the instructions may cause the processor to determine, as the suspect parent virus files, the subset of the other virus files that correspond to the differences in the plurality of differences with a lesser duration than the predetermined time period by: determining, for each of the plurality of differences, whether the difference is smaller than or lesser than a duration of the preset time period; when a particular difference among the plurality of differences is a lesser duration than the predetermined time period: obtaining a time, corresponding to the particular difference, when a particular virus file among the other virus files is first executed; obtaining the particular virus file corresponding to the time when the particular virus file is first executed; and determining the particular virus file as a suspect parent virus.

According to the embodiments, the child virus is firstly determined, and the computers containing the child virus are obtained; the time when the child virus first appears in the computers is obtained, and the time when each of virus files except the child virus in the computers is first executed is obtained; the difference between the time when the child virus first appears and the time when each of the virus files is first executed is calculated, and the virus files corresponding to the differences smaller than the preset time period are determined as the suspect parent viruses; and the parent virus is determined from the suspect parent viruses. Since the child virus is a virus file generated after executing the parent virus, based on a principle that the time when the parent virus is first executed is earlier than the time when the child virus first appears, the suspect parent viruses are determined, and the parent virus is found from the suspect parent viruses accurately.

Since some of the device embodiments substantially correspond to some of the method embodiments, some device embodiments may be implemented by referring to the description of the method embodiments. The device embodiments are described schematically, in which units explained as separated components may be or may not be physically separated, and components shown as units may be or may not be physical units. That is, the components may be located at one place, or distributed on multiple network units. In practice, part or all of the modules may be selected to realize the objective of the embodiment. Those of ordinary skill in the art may understand and implement the disclosure without paying any creative work.

It should be noted that, relational terms such as first and second herein are used to distinguish one entity or operation from another entity or operation, and do not necessarily require or indicate that any relationship or sequence exists between these entities or operations. In addition, terms “comprise”, “include” or any other variation thereof intends to be understood in a non-exclusive sense, so that a process, a method, an object or a device including a series of elements not only include these elements, but also includes other elements not explicitly listed, or further includes elements inherent in the process, the method, the object or the device. In the absence of more restrictions, element defined by a sentence “includes a . . . ” or “comprises a . . . ” does not exclude that other same elements also exist in the process, the method, the object or the device including said element.

The method and device for searching for the parent virus according to the embodiments of the disclosure are described in detail hereinabove. The principle and embodiments of the disclosure are illustrated with examples, and the description of the embodiments is adapted to facilitate understanding the method and spirit of the disclosure. Changes may be made on the embodiments and the application scope by those skilled in the art based on the spirit of the disclosure. Accordingly, the contents herein are not intended to limit the disclosure.

The methods, devices, systems, instructions, programs, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the device or system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for searching for a parent virus file, comprising:
determining an arbitrary virus file as a child virus file;
identifying a computer containing the child virus file;
identifying a time when the child virus file first appeared in the computer;
identifying times when other virus files contained in the computer that are different from the child virus file are first executed;
determining suspect parent virus files from among the other virus files, the suspect parent virus files being first executed within a predetermined time period before the time when the child virus file first appeared in the computer; and
determining the parent virus file from among the suspect parent virus files.

2. The method according to claim 1, further comprising, after determining the suspect parent virus files and before determining the parent virus file from among the suspect parent virus files:
obtaining an extent of each of the suspect parent virus files;
sequencing the suspect parent virus files in a descending order according to the extent of each of the suspect parent virus files; and
obtaining a first number of the suspect parent virus files; and
wherein determining the parent virus file comprises:
determining the parent virus file from among the first number of the suspect parent virus files.

3. The method according to claim 1, wherein determining the parent virus file comprises:
executing the suspect parent virus files; and
determining, as the parent virus file, a particular suspect parent virus file that generates the child virus file after being executed.

4. The method according to claim 1, wherein determining the suspect parent virus files from among the other virus files comprises:
calculating differences between the time when the child virus file first appeared in the computer and the times when the other virus files in the computer are first executed to obtain a plurality of differences; and
determining, as the suspect parent virus files, a subset of the other virus files that correspond to differences in the plurality of differences with a lesser duration than the predetermined time period.

5. The method according to claim 4, wherein determining, as the suspect parent virus files, the subset of the other virus files that correspond to the differences in the plurality of differences with a lesser duration than the predetermined time period comprises:
determining, for each of the plurality of differences, whether the difference is a lesser duration than the predetermined time period;
when a particular difference among the plurality of differences is a lesser duration than the predetermined time period:
obtaining a time, corresponding to the particular difference, when a particular virus file among the other virus files is first executed;
obtaining the particular virus file corresponding to the time when the particular virus file is first executed; and
determining the particular virus file as one of the suspect parent virus files.

6. A device for searching for a parent virus file, comprising:
a first determination module configured to determine an arbitrary virus file as a child virus file;
a first obtaining module configured to identify a computer containing the child virus file;
a second obtaining module configured to identify a time when the child virus first appeared in the computer;
a third obtaining module configured to identify times when other virus files contained in the computer that are different from the child virus file are first executed;
a second determination module configured to determine suspect parent virus files from among the other virus files, the suspect parent virus files being first executed within a predetermined time period before the time when the child virus file first appeared in the computer; and
a third determination module configured to determine the parent virus file from among the suspect parent virus files.

7. The device according to claim 6, wherein the device further comprises:
a fourth obtaining module configured to obtain an extent of each of the suspect parent virus files;
a sequencing module configured to sequence the suspect parent virus files in descending order according to the extent of each of the suspect parent virus files; and
a fifth obtaining module configured to obtain a first number of the suspect parent virus files; and
wherein the third determination module is configured to determine the parent virus file from among the first number of the suspect parent virus files.

8. The device according to claim 6, wherein the third determination module comprises:
an execution sub-module configured to execute the suspect parent virus files; and
a first determination sub-module configured to determine, as the parent virus file, a particular suspect parent virus file that generates the child virus file after being executed.

9. The device according to claim 6, wherein the second determination module comprises:
a first obtaining sub-module configured to calculate differences between the time when the child virus file first appeared in the computer and the times when the other virus files in the computer are first executed to obtain a plurality of differences; and
a second determination sub-module configured to determine, as the suspect parent virus files, a subset of the other virus files that correspond to differences in the plurality of differences with a lesser duration than the predetermined time period.

10. The device according to claim 9, wherein the second determination sub-module comprises:
a judgment unit configured to determine, for each of the plurality of differences, whether the difference is a lesser duration than the predetermined time period;
a first obtaining unit configured to, when a particular difference among the plurality of differences is a lesser duration than the predetermined time period, obtain a time, corresponding to the particular difference, when a particular virus file among the other virus files is first executed;
a second obtaining unit configured to obtain the particular virus file corresponding to the time when the particular virus file is first executed; and
a second determination unit configured to determine the particular virus file as the suspect parent virus files.

11. A non-transitory computer-readable medium storing a computer program, wherein execution of the computer program causes a processor to:
determine an arbitrary virus file as a child virus file;
identify a computer containing the child virus file;
identify a time when the child virus file first appeared in the computer;
identify times when other virus files contained in the computer that are different from the child virus file are first executed;
determine suspect parent virus files from among the other virus files, the suspect parent virus files being first executed within a predetermined time period before the time when the child virus file first appeared in the computer; and
determine a parent virus file to the child virus file from among the suspect parent virus files.
